(19) United States
(12) Patent Application Publication
(10) Pub. No.: US 2011/0220855 A1
(43) Pub. Date: Sep. 15, 2011

(54) Self-Cleaning Coating for Protection Against Hazardous Biopathogens and Toxic Chemical Agents Utilizing Both Super Hydrophobic Effects and Suitable Oxide Interfaces

(76) Inventors: John D. Weir, Huntington, NY (US); Ronald G. Pirich, Islip, NY (US); Dennis J. Leyble, Babylon, NY (US); Leonard G. Chorosinski, Ellicott City, MD (US); J. Donald Gardner, JR., Columbia, MD (US); Steven Chu, Ronkonkoma, NY (US)

(21) Appl. No.: 12/722,737

(22) Filed: Mar. 12, 2010

(51) Int. Cl. H01B 1/20; B82Y 30/00

(52) U.S. Cl. 252/519.33; 977/773

(57) ABSTRACT

A dual action self-cleaning and self-decontaminating coating consisting of a superhydrophobic aspect capable of cleaning the surface by having water droplets moving along the surface remove contaminants and a photochemically active aspect capable of disinfecting the surface by producing hydroxyl radicals in the presence of UV radiation and moisture.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates to self-cleaning coatings, and more particularly relates to dual action coating compositions having a super-hydrophobic substrate containing semiconductor metal oxide nanoparticles.

2. Description of Related Art

Contamination of exposed structural surfaces with chemical or biological material can occur in both civilian and military contexts. Contamination can occur accidentally, such as during the conveyance of hazardous materials from one site to another, or can occur on purpose, such as in chemical and/or biological warfare. Such materials can remain for a significant period of time on exposed surfaces, such as vehicles, aircraft, buildings, equipment, etc., and thereby remain as dangers to humans and animals that may come in contact with these surfaces.

Self-decontaminating coatings require several properties in addition to their ability to neutralize hazardous substances. The coatings must exhibit a degree of permanence over time and should desirably be self-cleaning and amenable to the incorporation of various pigments, thus making it possible to extend the time between cleanings by degrading and removing, as they are formed, marks which are gradually deposited at the surface of the substrate, in particular marks of organic origin, such as finger marks or volatile organic products present in the atmosphere, or even fungal growth.

One solution to these problems of dirty marks consists, for example, in depositing on the substrates a coating, which provides for degradation of those dirty marks by photocatalysis. Under the effect of radiation of appropriate wavelength, the components of the coating initiate radical reactions, which cause oxidation of organic products. This degradation can be induced by any compound which generates radicals under the effect of light (electromagnetic radiation).

It has been shown that the addition of certain semiconductor metal oxide nanoparticles to the surface of a material will give that material the capability of oxidizing organic matter on the surface. In particular, the crystallographic form of titanium dioxide (titania, TiO₂) known as anatase will absorb ultraviolet (UV) light (electromagnetic radiation) and in the presence of surface moisture will generate highly oxidative hydroxyl radicals. These hydroxyl radicals will oxidize and decompose any organic materials in their vicinity. Organic materials susceptible to such oxidation includes, but is not limited to, living material such as bacteria, spores, and viruses, along with hazardous and non-hazardous chemicals. This photocatalytic process is self-sustaining with UV light stimulation along with surface moisture derived from ambient humidity.

This self-decontaminating feature can be incorporated into a coating that can be used to protect surfaces from biological and chemical contamination. Since this reaction can also degrade the surface of the organic resin part of the coating, it is important to have a resin system or inorganic matrix that does not degrade over time, thereby making the coating useless for its intended purpose. Other suitable semiconductor oxides that can be utilized include tungsten trioxide (tungstic anhydride, WO₃), zinc oxide (ZnO), tin dioxide (cassiterite, SnO₂), zirconium dioxide (zirconia, ZrO₂), chromium dioxide (CrO₂), and antimony tetroxide (Sb₂O₄). A TiO₂ anatase or other aforementioned oxide additives that are small enough not to scatter visible light or act as a light blocking pigment, can be considered to allow the formation of an inorganic coating or for use with other pigments as an additive in an organic coating.

The problem with anatase in a coating system is that it is photochemically active and not a relatively inert pigment like the rutile form of TiO₂. Since rutile TiO₂ is relatively photochemically inert, the pigment protects the paint from degradation by scattering absorbed light. In contrast to the rutile pigment, the anatase form is photochemically active and as a result exterior paints formulated with the titanium dioxide anatase pigments are subject to heavy chalking. In order to solve the chalking problem and still maintain the advantages of the anatase for its photochemical reactivity, it may be necessary to have a coating system that is as photochemically inert to UV radiation as possible, as well as very resistant to oxidation by the hydroxyl radical. Either an inorganic coating matrix (as taught by U.S. Patent Application Publication No. 2010/0003498, the teachings of which are hereby incorporated by reference in their entirety) or an organic resin coating matrix (as taught by U.S. Patent Application Publication No. 2004/0224145, the teachings of which are hereby incorporated by reference in their entirety) may be utilized to meet this requirement.

Superhydrophobic surfaces can be said to be self-cleaning in that fluid droplets moving over a contaminated surface will pick up the contaminants as the droplet rolls along, and off of, the surface, thereby presenting a cleaning action. A surface is said to be hydrophobic if the surface has a large contact angle between the drop and the surface.

Superhydrophobic surfaces are found in nature, such as on a plant leaf or stem, but they can also be manmade as well by controlling surface chemistry compositions, as well as topography, for the surface requiring self-cleaning. In the case of plants, a major reason for self-cleaning ability is the leaf's surface is a combination of rough microstructures and the properties of these microstructures to repel water or fluids. The tops of the micro- or nanostructures are made of waxy materials, which are not very wettable, so the water runs off the plant and carries dirt and contaminants with it.

Water drops can exist in multiple states, depending on the surface the drop is located on. For example, a water drop on a smooth flat surface has a low contact angle and is known as “Young's wetting.” In contrast, on rough surfaces, the water droplet has a larger contact angle. When the contact angle is greater than 150 degrees and the roll-off angle (or sliding angle) of the drop surface is 10 degrees or less, the surface is said to be super-hydrophobic. The hysteresis for measuring the angles must be less than 10 degrees. When the droplet provides homogenous wetting, i.e., the droplet penetrates into the grooves of the rough surface, it is in the “Wenzel state.” However, when the droplet provides heterogeneous wetting and does not penetrate into the grooves of the rough surface, but rather sits atop the grooves, allowing for air to be trapped within the grooves and a composite surface to be formed, it is in the “Cassie state.” Since a droplet in the Cassie state does not completely wet the entire surface, the droplet will not remove all of the potential contamination when rolling over and off of the surface.

Accordingly, a significant further enhancement to the prior art coating systems is the use of a superhydrophobic surface for the self-cleaning of unwanted contamination which can be caught up in the cleaning liquid and/or droplets as the liquid rolls off the surface, while also having the capability to destroy contaminants remaining on the surface, thereby providing a dual self-cleaning and self-decontaminating effect from a single coating.

### BRIEF SUMMARY

The present invention relates to UV resistant surface coatings which exhibit photochemical activity that destroys toxic biological and chemical agents, and other contaminants. The UV resistance can be achieved through the use of an inorganic matrix (as taught by U.S. Patent Application Publication No. 2010/0003498) or an organic resin (as taught by U.S. Patent Application Publication No. 2004/0224145). These modified silicate based coatings have been proven to be extremely resistant to UV degradation and photochemical activity, while including the addition of photochemically active semiconductor metal oxide nanoparticles, e.g., anatase titanium dioxide, for the purpose of producing a coating that has the capability of destroying certain agent toxic to humans and/or animals. These agents can include, but are not limited to, toxic spores of anthrax, bacteria, viruses, and/or combinations of other toxic and communicable diseases, as well as nerve gas and other hazardous chemicals. Additionally, the present invention includes the element of the surface coating having a superhydrophobic component to allow for the self-cleaning of the surface by minimizing the Van der Waal's force.

Accordingly, most of the unwanted contaminants present on the surface will be removed by water droplets rolling over and off the surface and carrying away the contaminants. Any contaminants that remain on the surface will be rapidly oxidized and destroyed or neutralized in an atmosphere containing some water vapor (humidity) in the presence of ultraviolet light or an electromagnetic field due to the presence of the semiconductor metal oxide. The combination of the self-cleaning superhydrophobic component and the self-decontaminating semiconductor metal oxide component results in a synergistic effect allowing for a much improved self-cleaning/self-decontaminating surface coating over the prior art which may utilize only one of these components. For example, prior art surface coatings may become overloaded from an extreme amount of contaminants and not be able to remove or decontaminate the entirety of the contaminants. However, by combining the self-cleaning and self-decontaminating aspects, the present invention is able to decontaminate surfaces at a much higher level than the prior art allowed.

Applications for the present invention may include, but are not limited to, aircraft, ships, military vehicles, and other high value equipment, public places like subway stations, hospitals, railroad stations, stadiums, and the interior and exterior of buildings, and may be included in certain items such as ceramics, paints, metals, stone and cement, plastics, polymers, solar cells, traffic signs, sealants, moldings, sound barriers, light fixtures, cell phones, LCD displays, curtains, faucets, ovens, tents, paper rolls, eyeglass frames, and any other item that readily becomes dirty or contaminated.

The surface coating of the present invention may be applied to the substrate surface by any of multiple methods, including but not limited to, spraying, extrusion, casting, etching, an appliqué film, or any other suitable method.

The surface coating of the present invention allows for passive cleaning and decontamination of any surface it is applied to when exposed to UV and ambient moisture. This aspect of the present invention has a great benefit to the commercial and military fields as a low cost approach to cleaning surfaces without the use of toxic cleaning chemicals. Pollution prevention savings and labor savings is apparent from the discontinued use of such cleaning chemicals.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present invention relates to a self-cleaning and self-decontaminating surface coating composition having a superhydrophobic aspect to clean the surface and an oxidizing aspect to decontaminate the surface. The superhydrophobic component removes many contaminants from the surface by allowing moisture droplets to easily travel over and off the surface, while transporting contaminants. Any contaminants that are not thus removed from the surface are then oxidized, including decomposing and removing foreign organic and inorganic substances and preventing the growth of bacteria, viruses, fungi, and other living disease causing organisms. The surface coating is low in cost and energy usage, high in safety, provides non-polluting degradation products, and is able to sustain this effect over long periods on a maintenance-free basis.

A coating composition is made up of photochemically active semiconductor metal oxide nanoparticles dispersed in either an organic resin or an inorganic binder. The organic resin and inorganic binder are photochemically inert to UV radiation and resistant to oxidation by hydroxyl radicals. Additionally, the metal oxide nanoparticles form a surface structure that is at least partly hydrophobic.

The metal oxide nanoparticles can be any of TiO₂, WO₃, ZnO, SnO₂, ZrO₂, CrO₂, Sb₂O₄, and mixtures thereof. However, TiO₂ in the anatase form is the preferred metal oxide nanoparticle.

The organic resin can be a polyvinyl, alkyd, polyepoxy, polysiloxane, polyurethane, acrylnitrile, polyacrylate, chlorinated elastomer type, or mixtures thereof. However, these resins are not believed to provide sufficient protection against oxidation or degradation by the hydroxyl ions present and therefore the preferred organic resins used in the present invention are liquid crystal polymers or fluropolymers.

The inorganic binder may be dioxide, a silicate, or a mixture thereof. When utilizing an alkaline silicate, one may typically use sodium silicate, sodium disilicate, magnesium aluminum silicate, and the like.

The metal oxide nanoparticles typically comprise from about 1 percent up to about 30 percent by weight of the coating composition. For example, the metal oxide nanoparticles may comprise from about 1% to about 10% by weight of the coating composition, or from about 2% to about 5% by weight of the coating composition.

The metal oxide nanoparticles have a typical average size of less than 100 nm, usually within the range of about 20 nm to about 50 nm. The metal oxide nanoparticles are present in a physical form that is small enough not to scatter visible light or act as a light blocking pigment. However, the coating composition of the present invention may be mixed with other pigments which may be light blocking.

In order to be sufficiently hydrophobic to meet the anticipated needs of the present invention, the metal oxide nanoparticles should form a surface structure with a contact angle of at least 150 degrees and a roll-off angle of 10 degrees or less. To achieve these results, the topography of the nanoparticles (including periodicity and depth) may be varied to minimize the Van der Waal's force and the coefficient of friction.

The coating composition may further include additionally components, such as for example, poly(tetrafluroethylene), a solvent with water being a typical solvent), thickening agents, wetting agents, pigments, hardeners, and an overcoat layer. The overcoat layer may be applied over at least a portion of the surface coating and may be a polyurethane resin, an alkyd resin, and epoxy resin, and/or a latex resin.

The coating composition may be produced by an exemplary method of dispersing a colloidal suspension of TiO₂ in binder system with a solvent utilizing ultra-centrifugation and/or one or more of the following techniques: ultra-sonic dispersion, ball-milling, calendaring, high shear blade mixing, mechanical shear mixing, and extrusion or screw mixing.

The coating of the present invention has many unique and valuable features, including a long life with sufficient UV resistance while also being photochemically reactive due to the addition of TiO₂ in anatase form. This results in the ability to destroy toxic chemical agents and toxic biological agents such as bacteria or spores from, for example, anthrax on the surface of the coating. The coating is able to convert surface adsorbed hydroxyls to hydroxyl radicals to achieve such effect. These hydroxyl radicals will attack, oxidize, and destroy the toxic agents present on the surface.

Furthermore, due to the superhydrophobicity of the coating composition, it is sufficiently self-cleaning so as to keep the surface active in order to further continue to expose the anatase to UV radiation. The composition of the present invention may further be added to existing silicate formulations, for example AZ-93, which is a highly heat reflective coating used on spacecraft. The composition may be formed in a clear or colored format, while still allowing for sufficient UV reaction to occur on the surface with the anatase. Also the composition may be applied to numerous different substrates via brush, spray, powder, thermal spray, appliqué, or any other deposition technologies that lend themselves to this process.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A coating composition comprising: photochemically active semiconductor metal oxide nanoparticles dispersed in either an organic resin or an inorganic binder, wherein the organic resin or inorganic binder is photochemically inert to UV radiation and resistant to oxidation by hydroxyl radicals, and wherein the metal oxide nanoparticles form a surface structure that is at least partly hydrophobic.

2. The coating composition of claim 1, wherein the metal oxide nanoparticles are selected from the group consisting of TiO₂, WO₃, ZnO, SnO₂, ZrO₂, CrO₂, Sb₂O₄, and mixtures thereof.

3. The coating composition of claim 1, wherein the metal oxide nanoparticles are TiO₂ in the anatase form.

4. The coating composition of claim 1, wherein the organic resin is selected from the group consisting of fluoropolymers and liquid crystal polymers.

5. The coating composition of claim 1, wherein the inorganic binder is selected from the group consisting of silicon dioxide, a silicate, and mixtures thereof.

6. The coating composition of claim 5, wherein the inorganic binder is an alkaline silicate.

7. The coating composition of claim 6, wherein the inorganic binder is selected from the group consisting of sodium silicate, sodium disilicate, magnesium aluminum silicate, and mixtures thereof.

8. The coating composition of claim 1, wherein the metal oxide nanoparticles comprise up to about 30% by weight of the coating composition.

9. The coating composition of claim 8, wherein the metal oxide nanoparticles comprise from about 1% to about 10% by weight of the coating composition.

10. The coating composition of claim 1, wherein the metal oxide nanoparticles have an average size of less than 100 nm.

11. The coating composition of claim 1, further comprising poly(tetrafluroethylene).

12. The coating composition of claim 1, further comprising a solvent.

13. The coating composition of claim 12, wherein the solvent is water.

14. The coating composition of claim 1, wherein the surface structure forms a contact angle of at least 150 degrees.

15. The coating composition of claim 1, wherein the surface structure forms a roll-off angle of 10 degrees or less.
